(19) United States
(12) Patent Application Publication
(10) Pub. No.: US 2015/0373442 A1
(43) Pub. Date: Dec. 24, 2015

(54) J CAP AUDIO CAP

(71) Applicant: Jose Saucedo, Bensenville, IL (US)

(72) Inventor: Jose Saucedo, Bensenville, IL (US)

(21) Appl. No.: 14/743,624

(22) Filed: Jun. 18, 2015

Related U.S. Application Data
(60) Provisional application No. 62/013,774, filed on Jun. 18, 2014.

(51) Int. Cl. H04R 1/02; H04R 5/033

(52) U.S. Cl. CPC H04R 1/028; H04R 5/0335; H04R 2201/023

(57) ABSTRACT

Stereo headphones are incorporated into an attractive baseball cap wherein the headphones are attached to the cap with swivel mounted detachable snap fittings, a wire inside the cap which connects the headphones to each other, and a jack attached to the headphones which connects the headphones to an audio device. The swivel mounted detachable nap fittings can place the headphones in a variety of positions.

### CLAIM OF PRIORITY

This patent application claims priority under 35 USC 119 (e) (1) from U.S. Provisional Patent Application Ser. No. 62/013,774 filed Jun. 18, 2014, of common inventorship herewith entitled, “J CAP Audio Cap,” which is incorporated herein by reference as though the same were set forth in its entirety.

### FIELD OF THE INVENTION

The present invention pertains to the field of audio electronics, and more specifically to the field of hats containing headphones.

### BACKGROUND OF THE INVENTION

The prior art has put forth several designs for hats containing headphones. Among these are:

US Patent 2011/0286620 to Michael Flynn describes a hat mounted music system that includes a semi rigid hatband and a flexible crown and hat bill mounted to the hatband. A retaining pocket is mounted to the hatband and is sized and shaped to hold a portable music player. First and second headphone mounts are located to align with the ears of a user. The mounts have first and second hinges. First portions of the hinges are attached to the hatband and second portions of the hinges are attached to the mounts. The hinges permit movement of the mounts from a first, open position to a second, listening position. First and second headphone modules are adapted to fit the headphone mounts. Connection wires connect the player to the headphone modules. The headphone mounts are spring loaded and are retained in the second position by a latching mechanism. A release device allows the headphone mounts to return to the first, open position.

U.S. Pat. No. 6,305,026 to Chung Mo describes a cap with headphones assembly that provides a cap with removable headphones for permitting a user to listen to sound generating device connected to the headphones. The cap with the headphone assembly includes an article of headwear with a pair of side regions and a bottom opening for receiving a head of a user therein. A pair of ear pieces is provided each having an elongate arm outwardly extending therefrom. Each of the arms has a free end opposite the associated ear piece which is pivotally coupled to an associated side region. A first of the ear pieces has radio provided therein. Each of the ear pieces has a speaker electrically connected to the radio.

U.S. Pat. No. 4,858,248 to Steven E. Goldsmith and Joseph M. Santi describes a combined hat and earphones device that comprises a flexible hat positionable over the head and ears of a person, and a pair of earphones integrally and inconspicuously connected to lower portions of the hat such that the earphones are held adjacent the person's ears when the hat is being worn. The hat has an eyelet defined in an inner surface thereof, while electrical wires extending from the earphones extend downwardly out of the hat through the eyelet and have terminal ends thereof connected to a common plug member adapted to be received in the earphones jack of a portable radio or cassette player.

None of these prior art references describe the present invention.

### SUMMARY OF THE INVENTION

It is an object of the present invention to provide a line of stereo headphones and earphones incorporated into an attractive baseball cap.

### BRIEF DESCRIPTION OF THE DRAWINGS

FIG. 1 is an illustrative front diagonal view showing a headphone embodiment of the present invention comprising a baseball cap, attached headphones and a long headphone jack.

FIG. 2 is an illustrative front close up view showing the same embodiment with headphones in a functional position for fitting over a listener's ears.

FIG. 3 is an illustrative front close up view showing the same embodiment with headphones swiveled upwards over the baseball in a non functional position.

FIG. 4 is an illustrative front close up view of the same embodiment showing how the headphones are easily detachable.

FIG. 5 is an illustrative side close up view of the same embodiment showing how headphones swivel around the back of the cap in a non functioning position and how the headphone jack is retractable into the back of the baseball cap.

FIG. 6 is an illustrative front diagonal view showing an earbud embodiment of the present invention comprising a baseball cap, attached earbuds and a long earphone jack.

FIG. 7 is an illustrative top down diagonal close up view showing the same embodiment with retractable earbuds extending from the sides of the baseball cap.

FIG. 8 is an illustrative side close up view showing the same embodiment with both the earbuds and earphone jack retracted into the sides and back of the baseball cap respectively.

### DETAILED DESCRIPTION OF THE INVENTION

Millions of households are equipped with an assortment of electronic entertainment devices including stereo equipment, DVD players, MP3 players, and televisions. At the end of hectic and busy days, many people look forward to settling comfortably in their favorite chair or retreating to their bedroom to enjoy a favorite television program or music recording. Whether laughing along with a spirited sitcom or unwinding to a relaxing Brahms concerto, consumers turn to their TVs, radios, CD players, computers, iPods and smart phones for entertainment and solace. In an effort to respect other members of the household, many individuals utilize headphones to encapsulate the music or television noise into a medium that only they can hear. Using a connecting cord, the sounds from entertainment equipment travel to a headset fitted to each ear of the listener. Thanks to headphones, wives no longer are annoyed by booming noise of race cars when their husbands are entranced by a stock car competition. Parents no longer are subjected to splitting eardrums when their teenager decides to blast his favorite heavy metal band. In addition to sparing other members of the household from unwanted noise, headphones also provide listeners with a way to lose themselves in their chosen entertainment. Shutting out all outside distractions, the sounds going directly into their ears allow listeners to enter their very own sonic world.

As used herein the terms “headphones” and “earphones” are equivalent.

The present invention, hereinafter referred to as J CAP Audio Cap, or JCAP, is a line of functional stereo headphones or earbuds incorporated into an attractive baseball cap. JCAP provides consumers with a product that comfortably facilitates using headphones or earbuds while wearing a cap, blending entertainment and style in one functional device. Fabricated of durable fabric material and resembling standard baseball caps, the JCAP hat is offered in a variety of sizes, colors and designs to accommodate and appeal to all ages and sexes.

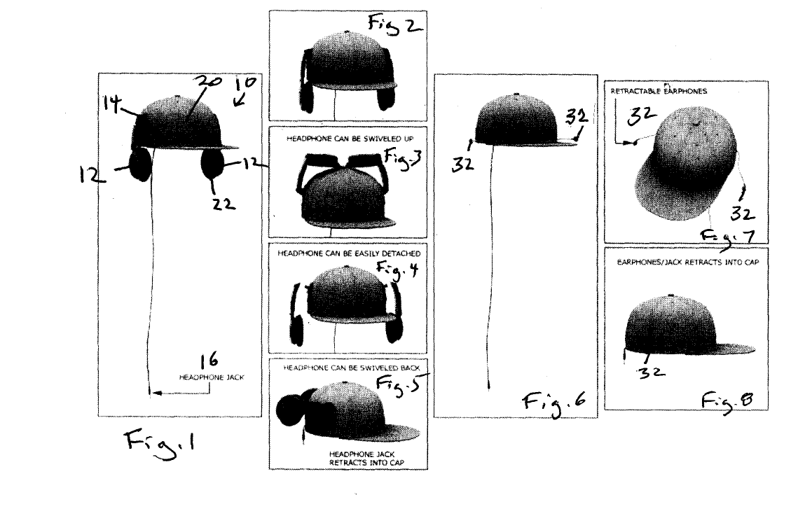

Please refer to the Figures. FIG. 1 shows the device 10 of the present invention having headphones 12 integrally attached to each side of a baseball cap 20 with swivel mounted detachable snap fittings 14, the lightweight headphones 12 are constructed in a familiar shape of cup style headphones. Each headphone 12 fits comfortably over a wearer's entire ear and is accentuated with cushiony and encapsulating borders 22 to reduce ambient noise and outside interference. Headphones 12 are connected to jack 16 which plugs the device 10 into a music or audio source. Swivel mounted detachable snap fittings 14 are capable of holding the headphones 12 in a position over the wearer's ears, as is shown in FIGS. 1 and 2. FIG. 3 shows the headphones 12 swiveled up and placed on the top of the cap 20. FIG. 4 shows the headphones 12 detachable from the cap 20. FIG. 5 shows the headphones 12 swiveled back and placed at the rear of the cap 20. A wire connecting the two headphones 13 to each other is inside the cap 20 and is not shown.

JCAP ensures optimal comfort as the headphones are raised and lowered as needed and even detached if necessary. A lightweight connection cord and jack 16 is attached to the rear of the hat 20 and accommodates any electronic entertainment device such as an MP3 player, tablet computer, laptop or smart phone, for example.

Headphones 12 can be made in any color to accent or match the color or design of the cap 20.

In an alternative embodiment, JCAP incorporates a compact and user friendly and earbud style of headphones, shown in FIGS. 6, 7 and 8. Earbuds 32 can be enhanced with color to match the parent hat 20.

Both embodiments of headgear are manufactured in any desired color combination and theme whether a simple solid color or multiple hues adorned with sports or corporate logos.

Eliminating the discomfort of trying to balance stereo headphones or earphones on their head when one wears these types of hats, a JCAP fits snugly with attached earphones conveniently raised above or lowered on to the ears as desired. By joining headphones and earphones with a cap, the present invention facilitates unimpeded enjoyment of entertainment while jogging, working out at the gym, riding the subway, warming up for sports practice or strolling across campus between classes. Millions of consumers who enjoy wearing caps, whether tech savvy teens or fun loving grandmothers, will appreciate the ability to bask in the sounds emanating from their headphones or earphones while displaying personal style with their chosen cap design. A JCAP shuts out the static of other people's portable entertainment, allowing a listener to only hear what is emanating through his or her headphones or earphones. Constructed of durable, high quality materials and easily adaptable to changing technology, JCAP will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A listening device comprising a pair of stereo headphones incorporated into a baseball cap, comprising: a pair of headphones integrally attached to each side of a baseball cap with swivel mounted detachable snap fittings, a wire inside the cap which connects the headphones to each other, and a jack attached to the headphones which connects the headphones to an audio device.

2. The listening device of claim 1, wherein the headphones are lightweight headphones in a familiar shape of cup style headphones and each headphone fits comfortably over a wearer's entire ear and is comprises a cushiony and encapsulating border to reduce ambient noise and outside interference.

3. The listening device of claim 1, wherein the headphones are connected to a jack which plugs the device into a music or audio source.

4. The listening device of claim 1 wherein swivel mounted detachable snap fittings are capable of holding the headphones in a position over the wearer's ears.

5. The listening device of claim 1 wherein swivel mounted detachable snap fittings are capable of holding the headphones in a position on the top of the cap.

6. The listening device of claim 1 wherein swivel mounted detachable snap fittings are capable of holding the headphones in a position at the rear of the cap.

7. The listening device of claim 1 wherein swivel mounted detachable snap fittings are capable of detaching the headphones from the device.

8. The listening device of claim 1, wherein the headphones are made in any color to accent or match the color or design of the cap.

9. The listening device of claim 1, wherein the headphones are earbuds.

10. The listening device of claim 9, wherein the earbuds are made in any color to accent or match the color or design of the cap.

11. The listening device of claim 9, wherein the earbuds are retractable into the cap.

12. The listening deice of claim 1, wherein the earphones and cap are manufactured in any desired color combination and theme including a simple solid color or multiple hues adorned with sports or corporate logos.
